(19) United States
(12) Patent Application Publication
(10) Pub. No.: US 2016/0116104 A1
(43) Pub. Date: Apr. 28, 2016

(54) Collapsible Three Legged Platform

(71) Applicant: Texas Custom Grills, LLC, Katy, TX (US)

(72) Inventors: Hunter R. Jaggard, Katy, TX (US); Griffin T. Jaggard, Katy, TX (US); Stephen H Jaggard, Houston, TX (US); Stephen P. Dunn, Houston, TX (US)

(73) Assignee: TEXAS CUSTOM GRILLS, LLC, Katy, TX (US)

(21) Appl. No.: 14/522,070

(22) Filed: Oct. 23, 2014

(51) Int. Cl. F16M 11/24; A47J 37/07

(52) U.S. Cl. CPC F16M 11/247; F16M 11/242; A47J 37/0763

(57) ABSTRACT

A collapsible three-legged platform is provided. The three legs are attached at a central pivot point such that the platform can collapse flat. The legs may be adapted to support a variety of objects.

### BACKGROUND OF INVENTION

1. Field of the Invention

This invention relates to a collapsible platform for securely supporting an object, for example, a wok. More particularly, a three-legged assembly pivotally secured together in such a way to enable the assembly to collapse for easy transport is disclosed.

2. Description of Related Art

Platforms for supporting objects are used in a variety of settings. For example, platforms may be used as a base for a table, chairs, or barbeque grills. Most platforms used for this purpose are physically attached to the supported structure and are not designed to be collapsible. However, a collapsible platform for holding a cocktail table has been disclosed (U.S. Pat. No. 4,315,467). Additionally, a portable tripod riser for supporting video equipment has been disclosed (U.S. Pat. No. 5,653,179).

For some applications, it is desirable for the platform to provide open space beneath the pivot point for additional storage. Current collapsible platform designs use a long pivot structure in order to provide strength for the overall platform. However, using a long pivot structure greatly diminishes the amount of available storage space beneath the pivot. There is a need for a collapsible platform that provides a large amount of open space beneath the pivot point while being strong and stable enough to safely support a heavy object.

### BRIEF SUMMARY OF THE INVENTION

A three-legged platform that is secured at a short pivot point, enabling the assembly to collapse flat for easy storage and transport while also providing a large amount of open space beneath the pivot point.

### BRIEF DESCRIPTION OF THE SEVERAL VIEWS OF THE DRAWINGS

FIG. 1 is an isometric top view of an embodiment of the assembly disclosed herein.

FIG. 2 is a plan view of an embodiment of the assembly disclosed herein with legs in the open position.

FIG. 3 is a plan view of an embodiment of the assembly disclosed herein in the collapsed position.

FIG. 4 is an exploded isometric top view of an embodiment of the assembly disclosed herein.

FIG. 5 is an exploded isometric top view of the central pivot point and locking mechanism of the assembly disclosed herein.

FIG. 6 is an isometric view of the central pivot point and locking mechanism of the assembly disclosed herein.

FIG. 7 is a cutaway view of the locking mechanism of the assembly disclosed herein.

### DETAILED DESCRIPTION OF THE INVENTION

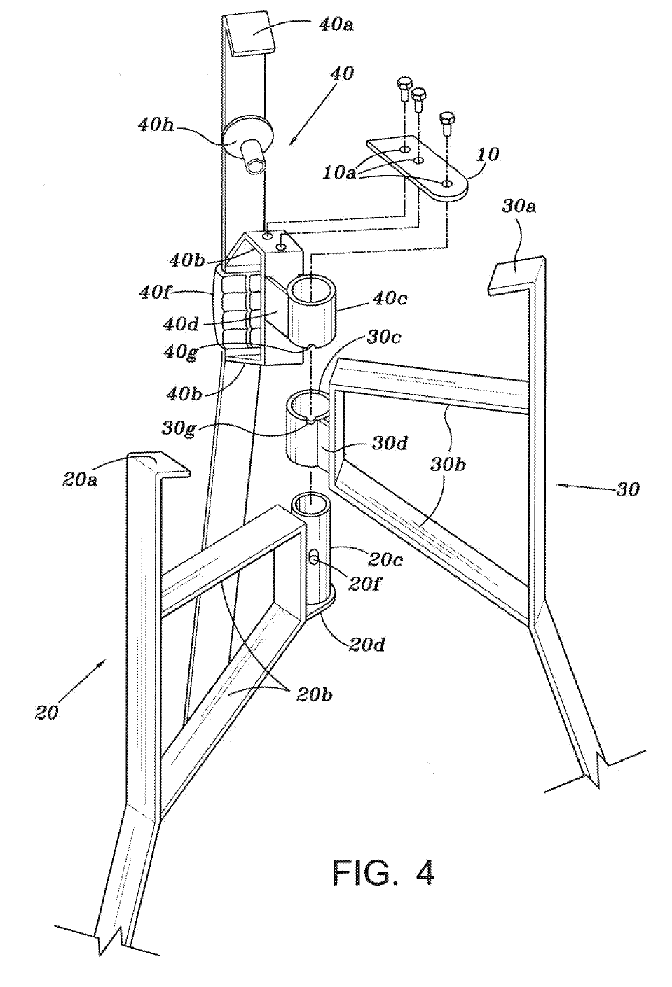

Referring to FIG. 4, an embodiment of the collapsible three legged platform includes three legs: leg 20, leg 30, and leg 40. The legs should be made from a strong material, preferably metal, such that they can support a significant amount of weight without deforming or breaking

Referring to FIG. 4, the top of each leg 20, 30, and 40 is bent at an acute angle as shown in 20a, 30a, and 40a such that the legs can support a lower spherical surface of an object. In another embodiment, the top of each leg may be bent to support a lower flat surface of an object.

Referring to FIG. 4, each arm 20b, 30b, and 40b is attached to legs 20, 30, and 40 respectively. In one embodiment, each arm is a trapezoidal shape, providing additional strength to the arm. Arm 40b is designed such that its trapezoid shape is slightly smaller where it connects to leg 40, providing additional space for a burner assembly attached to burner assembly connection 40h. Additionally, high friction grip 40f is attached to leg 40 where arm 40b connects to leg 40. High friction grip 40f may be made of rubber or similar material and molded such that it provides an optimum surface for gripping the collapsible three legged platform.

Referring to FIG. 4, extension elements 30d and 40d are attached to arms 30b and 40b respectively. Cylindrical sleeves 30c and 40c are attached to the end of extension elements 30d and 40d. Cylindrical sleeves 30c and 40c are hollow.

Referring to FIG. 4, central pivot post 20c is attached to arm 20b and is appropriately sized so that it can be inserted into sleeves 30c and 40c. Together, 20c, 30c, and 40c form a central pivot point for the collapsible platform assembly. Additionally, lower capping member 20d is attached to arm 20b and an end of central pivot post 20c. Lower capping member 20d is larger than the central pivot post 20c to prevent sleeves 30c and 40c from sliding off the end of the central pivot post 20c. Finally, upper capping member 10 is attached to the top of arm 40b by screws through screw holes 10a. An end of upper capping member 10 extends past arm 40b and over central pivot post 20c such that it covers the top of central pivot post 20c.

Referring to FIG. 4, central pivot post 20c contains a hole for receiving spring pin button 20f, shown in FIG. 7.

Referring to FIG. 7, spring pin button 20f is attached to spring 20g. Spring 20g is inserted into central pivot post 20c and spring pin button 20f is inserted into the hole in central pivot post 20c.

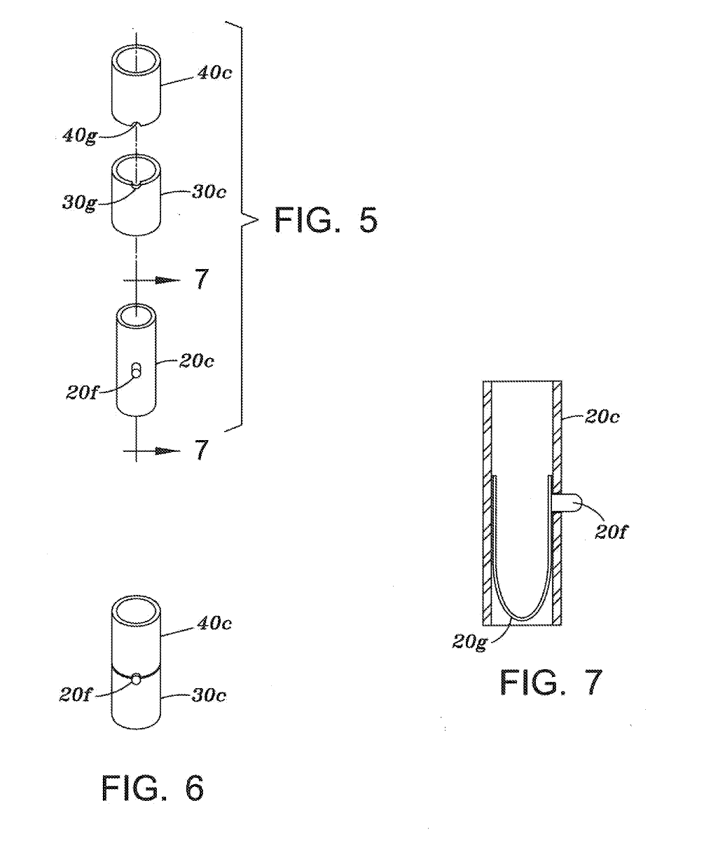

Referring to FIG. 5, the bottom end of cylindrical sleeve 40c has notch 40g for receiving the spring pin button 20f. The top end of cylindrical sleeve 30c has notch 30g for receiving spring pin button 20f.

As shown in FIG. 6, when fully assembled, the spring pin button 20f and the notches 30g and 40g form a locking mechanism restraining cylindrical sleeve 30c and cylindrical sleeve 40c from rotating about central pivot post 20c. When the spring pin button 20f is depressed, cylindrical sleeve 30c and cylindrical sleeve 40c can rotate freely about the central pivot post 20c. This allows the assembly to be collapsed from the extended structure shown in plan view in FIG. 2 to the flat structure shown in plan view in FIG. 3.

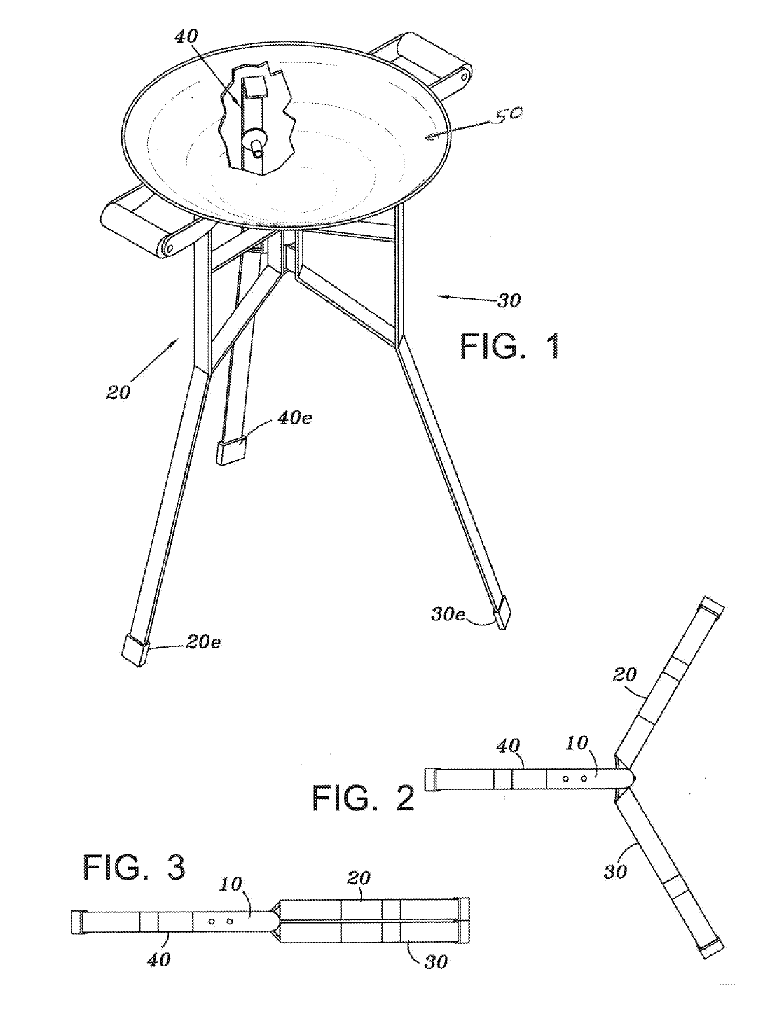

Referring to FIG. 1, high friction feet 20e, 30e, 40e may be attached to the bottom of legs 20, 30 and 40 respectively such that they provide a flat surface or additional friction against the supporting surface. Wok 50 or other objects may be placed on the collapsible platform and the legs adapted to support the object.

The collapsible three legged platform disclosed herein is particularly suited for supporting a grill having a spherical lower surface, similar to a wok. The bottom portion of the legs may be adapted to be extended to provide additional space beneath the central pivot post.

Although the present invention has been described with respect to specific details, it is not intended that such details be regarded as limitations on the scope of the invention, except to the extent that they are included in the accompanying claims.

I claim:

1. A collapsible platform assembly, comprising:
a first leg having an arm perpendicularly attached thereto, the arm having attached thereto a lower capping member and a central pivot post, the central pivot post having an opening and a spring pin button therethrough;
a second leg having an arm perpendicularly attached thereto, the arm having attached thereto an extension element and a first sleeve, the first sleeve having a notch in an upper surface and being adapted to be placed over the central pivot post; and
a third leg having an arm perpendicularly attached thereto, the arm having attached thereto an extension element and a second sleeve, the second sleeve having a notch in a lower surface and being adapted to be placed over the central pivot post, and a fastening mechanism for attaching an upper capping member to be disposed over the second sleeve.

2. The collapsible platform assembly of claim 1 wherein an upper end of the first, second and third leg is formed to adapt to a flat or curved surface placed on the assembly.

3. The collapsible platform assembly of claim 1 further comprising high friction feet on the lower end of the first, second and third leg.

4. The collapsible platform assembly of claim 1 further comprising a high friction grip attached to a leg.

5. The collapsible platform assembly of claim 1 further comprising a burner assembly connection attached to a leg.
